(19) United States
(12) Patent Application Publication
(10) Pub. No.: US 2009/0314579 A1
(43) Pub. Date: Dec. 24, 2009

(54) Ladder stabilizer

(76) Inventor: Allan Withers, Landsdowne, PA (US)

Correspondence Address: Daniel S. Kirshner;Attorney at Law, 199 Route 18 South, East Brunswick, NJ, 08816, US

(21) Appl. No.: 12/214,335

(22) Filed: Jun. 18, 2008

(51) Int. Cl. E06C 7/10

(52) U.S. Cl. 182/107

(57) ABSTRACT

A ladder stabilizer to be utilized in conjunction with and to stabilize an A-frame ladder. The ladder stabilizer of the present invention comprises an I-shaped attachment plate which has screw holes for attachment to the ladder. Extending angularly downward from the attachment plate is a first leg member. A second leg member fits inside the first leg member and is sized and shaped appropriately so that it may telescope in and out with respect to the first leg member for leg length adjustment. At the bottom of the leg, the second leg member is angled downward so that the bottom of the leg will rest securely on the ground or floor.

### FIELD OF THE INVENTION

The present invention is a ladder stabilizer to be utilized in conjunction with an A-frame ladder. More specifically, the present invention ladder stabilizer comprises a telescoping leg attached to an attachment plate, which attachment plate is utilized for attachment to the ladder.

### SUMMARY OF THE INVENTION

The present invention is a ladder stabilizer to be utilized in conjunction with and to stabilize an A-frame ladder. The ladder stabilizer of the present invention comprises an I-shaped attachment plate which has screw holes for attachment to the ladder. Extending angularly downward from the attachment plate is a first leg member. A second leg member fits inside the first leg member and is sized and shaped appropriately so that it may telescope in and out with respect to the first leg member for leg length adjustment. At the bottom of the leg, the second leg member is angled downward so that the bottom of the leg will rest securely on the ground or floor. The ladder stabilizer is attached to the ladder by positioning the attachment plate adjacent to a leg of the ladder, inserting screws through the screw holes of the attachment plate and screwing the attachment plate to a pressure plate positioned on the opposite side of the ladder leg thereby sandwiching the leg and securing it.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a side view of the present invention ladder stabilizer attached to a prior art step ladder.

FIG. 2 is a top view of the attachment plate of the present invention.

FIG. 3 is a side view of the first leg member attached to the attachment plate of the present invention.

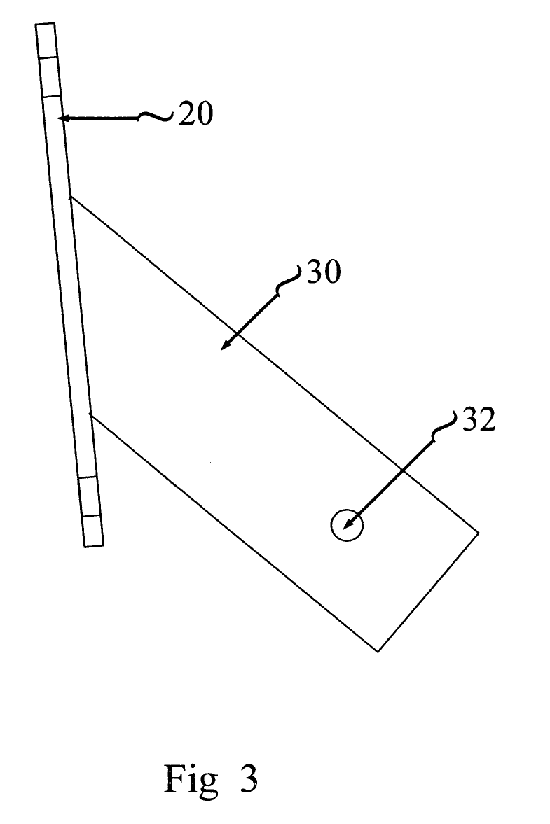

FIG. 4 is a side view of the second leg member of the present invention.

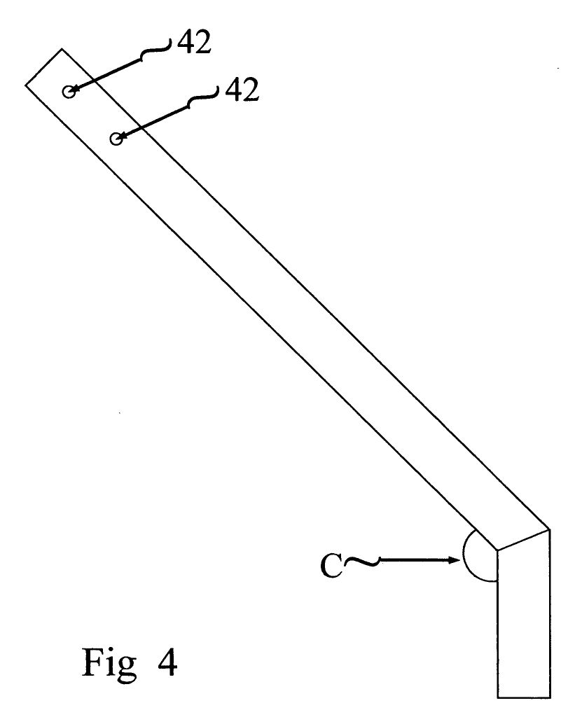

FIG. 5 is a front view of the present invention.

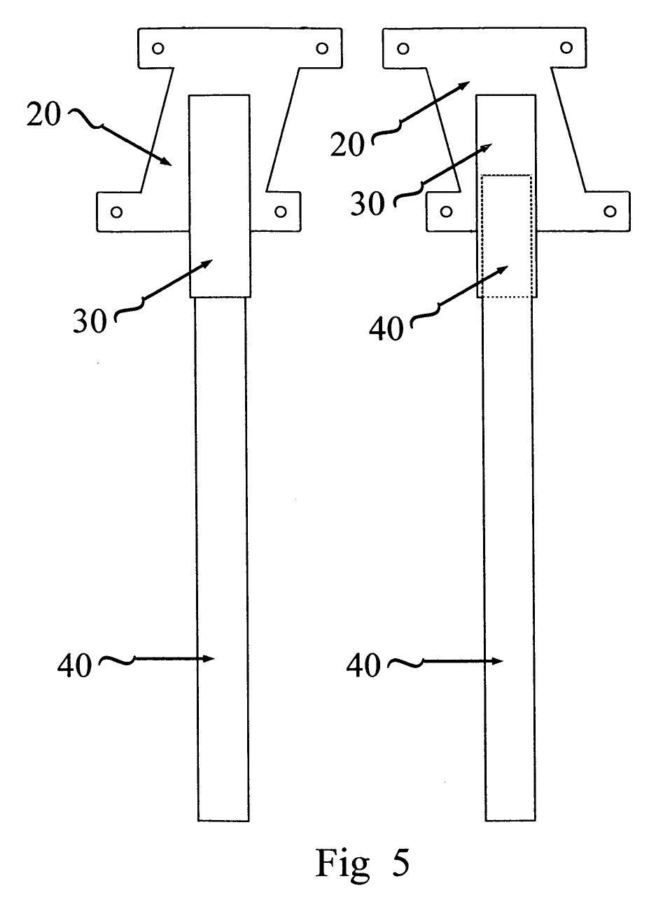

FIG. 6 is front view of the present invention attached to the leg of a prior art step ladder.

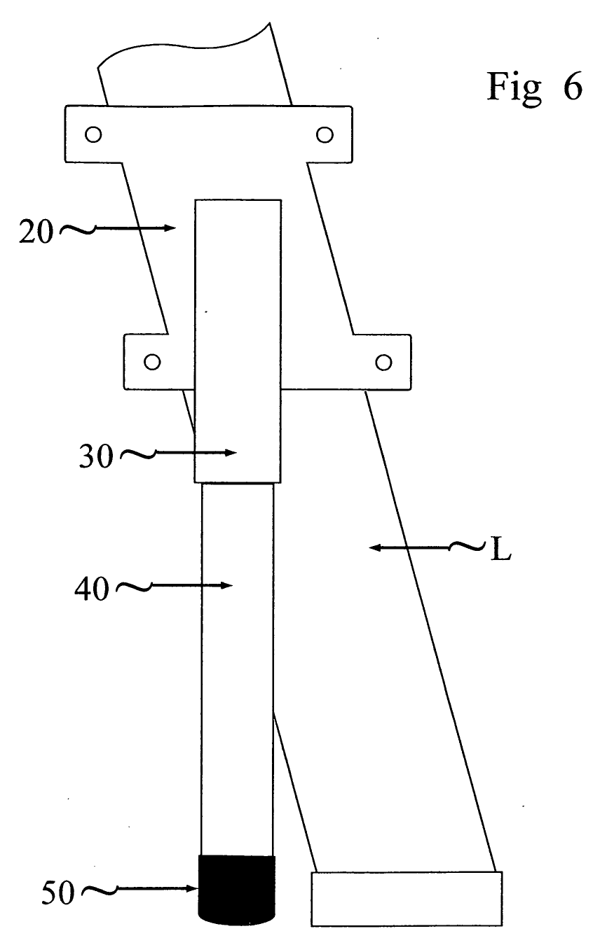

FIG. 7 is a side view of the present invention attached to the leg of a prior art step ladder.

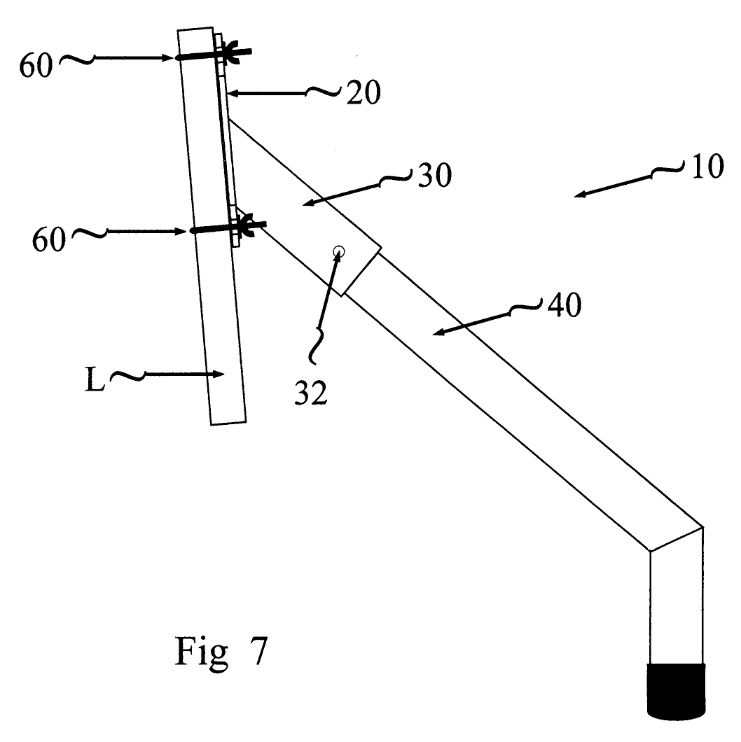

FIG. 8 is a cross-sectional view of the present invention attached to the leg of a prior art step ladder.

### DETAILED DESCRIPTION OF THE INVENTION

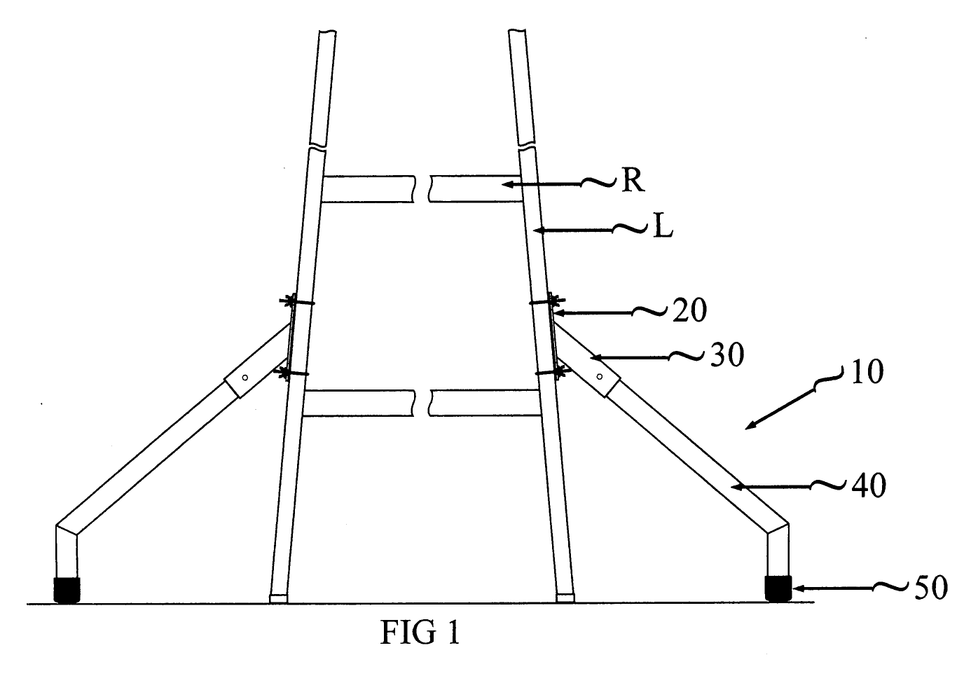

Referencing the drawings, the present invention is a ladder stabilizing device to be employed in connection with an A-frame ladder. Referring to FIG. 1, a typical A-frame ladder comprises four legs L angularly attached at the top, and rungs R spanning the legs. One or more ladder stabilizer devices 10 of the present invention, are attached to the side of one or more of the legs of the ladder and contact the ground thereby providing added stabilization to the ladder.

Still looking at FIG. 1, the ladder stabilizer 10 comprises generally an attachment plate 20 for attachment to at least one leg L of a ladder, a first leg member 30, and a second leg member 40 that cooperates telescopically with the first leg member. The attachment plate, the first leg member and the second leg member are formed from steel, however any strong and rigid material may be employed.

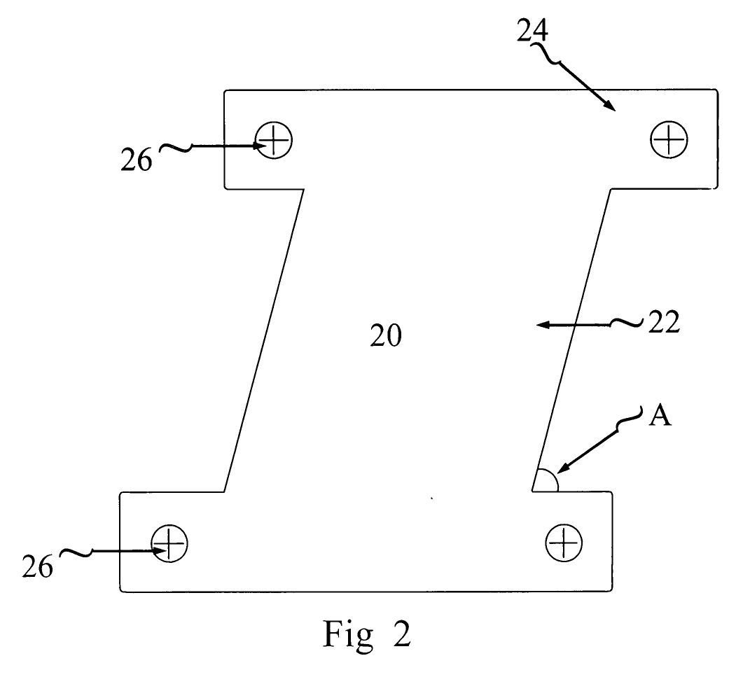

The attachment plate shown in FIG. 2 is generally I-shaped having a vertical member 22 and a first and second horizontal member 24 located horizontally at the top and bottom of the vertical member. The attachment plate is formed from flat stock steel, however any strong and rigid material may be employed. In the preferred embodiment shown herein, the vertical member extends upward angularly from the bottom horizontal member, wherein angle ‘a’ shown in FIG. 2 is approximately 75°, which angle corresponds approximately to the upward angle of a leg of the ladder with the respect to the ground. Alternatively, the vertical member may be situated at a right angle with respect to the top and bottom members of the attachment plate. Four screw holes 26 are positioned on the top and bottom members of the attachment plate (two screw holes on the top horizontal element and two on the bottom horizontal element) which said screw holes are utilized to secure the stabilizing device to a pressure plate thereby sandwiching and securing the leg of the ladder.

Attached to the attachment plate is the first leg member 30, said first leg member 30 being the outer tube of the telescoping leg. The first (outer) leg member is welded to the attachment plate and extends angularly downward from the attachment plate. The downward angle ‘b’ of the first leg member relative to the attachment plate is approximately 45°. As shown in the figures, the first (outer) leg member has a hollow bottom for telescopic insertion of the second leg member and has a substantially square cross-section with each side measuring approximately 1.50 inches. Other configurations, including a hollow member having a circular cross-section are included in this disclosure. A pair of lock-pin apertures 32 is positioned on the first leg member wherein the lock-pin apertures are positioned on opposite sides of the leg in the same location on the sides thereby enabling a lock pin to be inserted therethrough.

The second leg 40 (inner leg) of the telescoping leg assembly is shaped and configured to fit inside the first leg member, yet is able to slide freely in and out of the first leg. As such, as disclosed herein, the second leg member also has a square cross-section with the sides of the leg slightly smaller than the sides of the first leg member. Of course, in the event the first leg member is circular or has other configuration, the second leg member should be similarly configured. Specifically, the embodiment disclosed herein has a square cross section having sides measuring approximately 1.25 inches thereby enabling the top of the second leg to slide within the bottom of the first leg in telescopic fashion so that the user may chose an appropriate overall leg length depending on the size of the ladder and the position that the device is attached to the ladder. The second leg 40 is angled downward near its bottom wherein the bend ‘c’ forms an angle of approximately 45°. The length of the second leg member from the top edge to the bend is approximately 15.5 inches and the length of the leg below the bend is approximately 4 inches. At least one pair, and preferably a plurality of pairs of lock-pin apertures 42, is positioned on the second leg. The second-leg lock-pin apertures are positioned on opposite sides of the leg in the same location on the sides and in a location selected to line-up with the lock-pin apertures on the first leg. Therefore, a user may insert the lock-pin completely through the pairs of lock-pin apertures on the first and second legs thereby locking the position of the two legs relative to each other. In this manner, the user can slide the inner leg into and out of the outer leg telescopically, thereby selecting the appropriate overall leg length. Preferably, the lock pin is tethered to the stabilizing device to prevent its loss.

At the bottom of the second leg, the leg tapers to a section of smaller cross-section. A rubber foot 50 is placed on this section of smaller diameter which serves to prevent slippage when the foot is put into place on the ground.

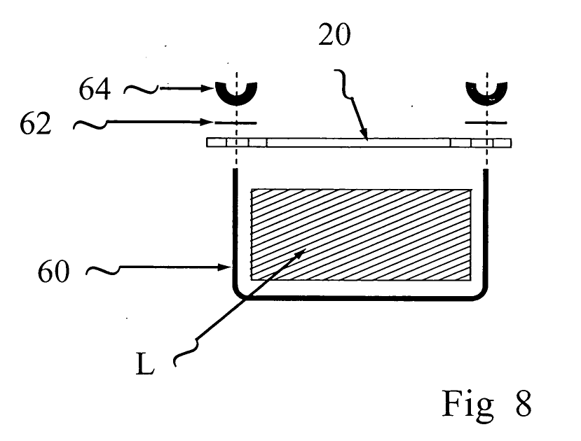

Referring back to FIG. 1 and seen in conjunction with FIG. 8, the present invention A-frame ladder stabilizer is employed by positioning it in the appropriate position with the attachment plate abutting a leg of the ladder and the leg extending in a downward direction. The user slides the second leg member relative to the first and locks the two legs in plate utilizing the lock pin so that the bottom of the leg (the rubber foot 50) rests firmly on the floor or ground. Now, square U-bolts are inserted through the four screw holes on the attachment plate. A back pressure plate 60 formed from steel is provided, which pressure plate is U-shaped and has screw holes in the same locations as the horizontal members of the attachment plate. The pressure plate is positioned on the opposite side of the leg of the ladder so that its screw holes align with those of the attachment plate. Bolts are now inserted through the screw holes on the pressure plate and the attachment plate thereby sandwiching the leg of the ladder and securing it to the ladder by employing washers 62 and wing nuts 64. As is evident, the stabilizing device is secured non-permanently to stabilize the A-frame ladder. The stabilizing device is easily removable for storage or for utilization on another ladder or in another location.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

What is claimed:

1. A device for stabilizing an A-frame ladder said ladder having a leg, comprising:
an attachment plate, said attachment plate being I-shaped having a vertical element and two horizontal elements, said two horizontal elements each having at least one screw hole,
a first leg member attached to the said attachment plate and extending downward therefrom at an angle of approximately 45° with respect to the attachment plate, said first leg member and including a hollow bottom section, and further including a pair of lock pin apertures;
a second leg member sized and configured to fit inside said bottom of said first leg member and slide in and out thereof telescopically, said second leg member having a bend downward at an angle of approximately 45°, said second leg member including at least one pair of lock pin apertures;
a lock pin for insertion through the said lock pin apertures of the first leg and the second leg, thereby locking the first leg and the second leg together; and
a pressure plate, said pressure plate attached to the attachment plate of the stabilizing device, said pressure plate and said attachment plate sandwiching the said leg of the ladder thereby securing the stabilizing device to the ladder.
